(19) United States
(12) Patent Application Publication
(10) Pub. No.: US 2013/0161056 A1
(43) Pub. Date: Jun. 27, 2013

(54) FLAME AND OIL RESISTANT HALOGEN-FREE COMPOSITION

(71) Applicant: Viakable, S. A. de C. V., San Nicolas de los Garza (MX)

(72) Inventor: VÍCTOR HUGO PONCE IBARRA, SAN NICOLÁS DE LOS GARZA (MX)

(73) Assignee: VIAKABLE, S. A. DE C. V., SAN NICOLÁS DE LOS GARZA (MX)

(21) Appl. No.: 13/715,378

(22) Filed: Dec. 14, 2012

(30) Foreign Application Priority Data
Dec. 16, 2011 (MX) MX/A/2011/013927

(51) Int. Cl. C09D 123/08; C09D 151/00; H01B 7/295; C09D 123/06

(52) U.S. Cl. CPC C09D 123/08; C09D 123/06; C09D 151/003; H01B 7/295
USPC 174/102 C; 524/405

(57) ABSTRACT

A flame and oil resistant halogen-free composition, that is extrudible and suitable for electric cable sheaths, having from 5% to 25% by weight of at least one ethylene copolymer, from 5% to 25% by weight of linear low density polyethylene, from 0.5% to 25% by weight of at least one polyolefin grafted with maleic anhydride, and from 40% to 80% by weight of at least one flame retardant. This composition is resistant to immersion in oil over 60 days at an oil temperature of 60° C.

### TECHNICAL FIELD OF THE INVENTION

This invention relates to the field of compositions for electric or data communication cable sheaths and more precisely, to a halogen-free composition that is resistant to oil and to the spreading of fire, which is extrudible and suitable for the coating of insulating or the covering of electrical conductors.

### BACKGROUND OF THE INVENTION

Insulated electrical cables and/or coated with halogen-free materials are high performance products, as they offer the appropriate balance of high operating temperature properties, fire resistance, water resistance, abrasion resistance, acceptable electrical properties and flame resistance. When these wires burn, they emit very small amounts of smoke, which, as they are not halogenated, are non-corrosive. However, compared with other halogen-containing polymers, halogen-free polymer based oleophilic materials inherently have a very low oil resistance, by virtue of the chemical similarity between said polymers and the test fluid, normally a mineral oil.

Under test conditions, oil is introduced to the compound, causing swelling, which weakens the material mechanically. Under extreme conditions, particularly when the test temperature is raised, the thermoplastic material is completely dissolved in the hot oil. To correct this situation, these materials usually intersect, which is an additional process that increases the cost and complexity of the industrial process.

There are two levels of severity of oil resistance tests, normally used in halogen-free thermoplastic materials. The first one considers the oil immersion for 4 hours at 70° C. and the most severe one considers immersion in oil for 96 hours at 100° C. These tests involve the immersion for specified periods and temperatures, of samples of said materials. Used oil is the IRM 902, which is the industry standard. The oil resistance is evaluated by measuring, before and after immersion, the tensile properties of the material, i.e., the stress and elongation. A material is considered oil resistant when its tensile properties are only affected to a minimum by immersion in oil. UL44 and/or IEE1580 standards for electrical cables specify in a detailed manner the requirements, either for the shell material or for the finished cable.

Some examples of current compositions related to halogen-free and oil resistant covers or insulation, are found described in the following patent documents:

Fredericke Maringer Melvin et al. in the French patent FR-2419957 discloses a polymeric composition resistant to oil and heat, containing an ethylene-vinyl acetate (EVA), chlorinated polyethylene (PEC) and hydrated alumina. This composition contains 10 to 50 parts of PEC and 70 to 300 parts of hydrated alumina, per 100 parts by weight of EVA, the EVA copolymer containing 20% to 90% by weight of vinyl acetate (VA).

Jack Raymond Pedersen, in the European patent EP-0241330B1 discloses an electrical wire or of telecommunications used in petrochemical installations containing an oil-resistant insulating sheath and composed of a mixture of polyethylene and a polyamide in a base of ethylene copolymer.

Silvestro Cartasegna et al. published the British patent application GB-2190384, disclosing thermoplastic compositions that are flame retardant and oil resistance at 70° C. These compositions contain a homopolymer or copolymer of ethylene, an elastomer, a copolymer of ethylene and an unsaturated carboxylic acid, and the flame retardant load.

Manuel La Rosa et al. published the international patent application WO2010/020586A1, disclosing thermoplastic compositions that are flame retardant that can be used as insulation or electric cable sheaths with oil resistance at 70° C. These compositions contain thermoplastic polymer, ethylene copolymer and vinyl acetate of with a vinyl acetate content greater than 40% by weight, a copolymer of ethylene and a C4-C8 olefin produced with metallocene catalysts, this component being different from the thermoplastic polymer, and polymer or copolymer modified with an unsaturated carboxylic acid, and flame retardant.

### SUMMARY OF THE INVENTION

In view of the above and with the object of finding solutions to the limitations encountered, it is object of the invention to provide a flame and oil resistant halogen-free composition for electric cable sheath having from 5% to 25% by weight of at least one ethylene copolymer, from 5% to 25% by weight of linear low density polyethylene, from 0.5% to 25% by weight of at least one polyolefin grafted with maleic anhydride, and from 40% to 80% by weight of at least one flame retardant.

Another object of the present invention is to provide the use of a flame and oil resistant halogen-free composition for an electric cable sheath, the composition comprises from 5% to 25% by weight of at least one ethylene copolymer, from 5% to 25% by weight of linear low density polyethylene, from 0.5% to 25% by weight of at least one polyolefin grafted with maleic anhydride, and 40% to 80% by weight of at least one flame retardant.

Another object of the present invention is to provide an electric cable having at least one electrical conductor, and at least one flame and oil resistant halogen-free sheath covering the electrical conductor, the flame and oil resistant halogen-free sheath includes from 5% to 25% by weight of at least one ethylene copolymer, from 5% to 25% by weight of linear low density polyethylene, from 0.5% to 25% by weight of at least one polyolefin grafted with maleic anhydride, and from 40% to 80% by weight of at least one flame retardant.

### BRIEF DESCRIPTION OF THE FIGURES

The characteristic details of the invention are described in the following paragraphs in conjunction with the accompanying figures, which are for the purpose of defining the invention but without limiting its scope.

FIG. 1 shows a sectional perspective view of a cable with halogen-free thermoplastic insulation according to the invention.

### DETAILED DESCRIPTION OF THE INVENTION

The characteristic details of the invention are described in the following paragraphs, which are for the purpose of defining the invention but without limiting its scope.

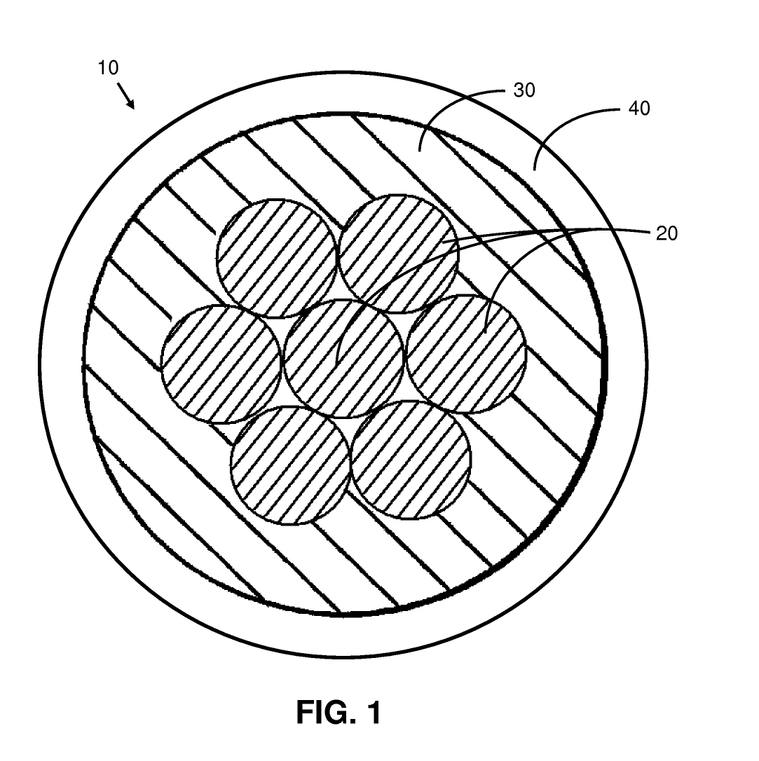

In FIG. 1, a cable 10 is shown, comprising one or more conductors 20, one or more insulating sheaths 30, and one or more sheaths 40 wherein at least one of these sheaths comprises a flame and oil resistant halogen-free composition according to the invention.

The flame and oil resistant halogen-free composition for an electrical cable sheath according to the invention shows compounds that in turn could consist of multiple components.

The compounds are described individually below, without necessarily being described in an order of importance.

### Compound I: Ethylene Copolymer

The flame and oil resistant halogen-free composition of the present invention contains one or more polymers based on ethylene copolymers with at least one alpha-olefin such as ethylene/alpha-olefin copolymers or ethylene/alpha-diene which are obtainable by copolymerizing ethylene with an alpha-olefin, and optionally with a diene, in the presence of a metallocene catalyst.

By the term alpha-olefin is meant an olefin of formula CH₂═CH—R, wherein R is a linear or branched alkyl having 1 to 10 carbon atoms. The alpha-olefin may be selected, for example, from propylene, 1-butene, 1-pentene, 4-methyl-1-pentene, 1-hexene, 1-octene, 1-dodecene, and the like. Propylene is particularly preferred.

When an alpha-olefin is present, this is usually selected from linear diolefins, conjugated or unconjugated, for example 1,3-butadiene, 1-4-hexadiene or 1,6-octadiene; monocyclic or polycyclic dienes, for example 1,4-cyclohexadiene, 5-ethyldiene-2-norbornene, 5-methylene-2-norbornene, and the like.

The ethylene copolymer with at least one alpha-olefin that can be used according to the inventions is m-poly(ethylene-co-1-octene).

Examples of polymers based on ethylene copolymer useful in the flame and oil resistant halogen-free composition of the present invention are: ethylene copolymers of vynil, ethylene-co-1-hexene, ethylene-co-1-butene, ethylene-co-1-octene, ethylene-co-methylacrylate, ethylene-co-ethylacrylate, ethylene-co-butylacrylate, ethylene-co-butyl acrylate-co-carbon monoxide, ethylene-co-vinylacetate-co-carbon monoxide, and combinations thereof.

The flame and oil resistant halogen-free composition of the invention has an ethylene copolymer content of about 5% to about 25% by weight of the total composition, and in a more particular embodiment, the ethylene copolymer content is about 10% to about 20% by weight.

Preferred ethylene copolymers are ethylene acetate copolymers.

The ethylene copolymer leads to improved processability and charge interaction and, in particular, while using ethylene acetate copolymer an even better interaction is provided with the charges and a better response to the flame.

### Compound II: Linear Low Density Polyethylene

The flame and oil resistant halogen-free composition of the present invention contains one or more linear low density polyethylenes.

The linear low density polyethylene may have a density in the range from about 0.89 g/cm3 to about 0.93 g/cm3, and is preferably in the approximate range of 0.915 g/cm3 to 0.925 g/cm³. The melt index can be in the approximate range of 0.1 g/min to 25 g/min, and is preferably in the approximate range of 2 g/min to 10 g/min.

The amorphous and crystalline structures of linear low density polyethylene allow a better balance between interaction with the other components, and maintain dimensional stability during exposure to a high temperature and oil.

The flame and oil resistant halogen-free composition of the invention has a linear low density polyethylene content of about 5% to about 25% by weight of the total composition, and in a more particular embodiment, the linear low density polyethylene content is about 10% to about 15% by weight.

### Compound III: Compatibilizer (Polyolefin Grafted with Maleic Anhydride)

The flame and oil resistant halogen-free composition of the present invention, contains at least one compatibilizer related to the ethylene copolymer, in particular as a compatibilizer, at least one polyolefin grafted with maleic anhydride is preferred.

Examples of polyolefins grafted with maleic anhydride useful in the halogen-free, flame and oil resistant composition of the present invention are: low density polyethylene grafted with maleic anhydride, linear low density polyethylene grafted with maleic anhydride, polypropylene grafted with maleic anhydride, high density polyethylene grafted with maleic anhydride, ethylene copolymer grafted with maleic anhydride, and combinations thereof.

Polyolefins grafted with maleic anhydride provide better interactions between fillers and polymers, moreover, enhancing response to the flame.

The flame and oil resistant halogen-free composition of the invention has a polyolefin grafted with maleic anhydride of about 5% to about 25% by weight of the total composition, and in a more particular embodiment, the linear low density polyethylene content is about 5% to about 10% by weight.

### Compound IV: Flame Retardants

The flame and oil resistant halogen-free composition of the present invention contains at least one flame retardant, whether synthetic or mineral by origin, and at the same time is used as a filler in the present composition, so that it can function as a flame retardant and/or cost reductor for the final composition.

A wide variety of flame retardants, synthetic or mineral by origin may be useful in the flame and oil resistant halogen-free composition of the present invention. Examples of flame retardants of synthetic origin are: synthetic alumina trihydrate, treated alumina trihydrate, synthetic magnesium hydroxide, treated magnesium hydroxide, synthetic magnesium-aluminum layered double hydroxide, treated magnesium-aluminum layered double hydroxide, zinc borate, and combinations thereof. Examples of flame retardants of mineral origin are: natural alumina trihydrate, natural magnesium hydroxide, natural magnesium-aluminum layered double hydroxide, and combinations thereof.

In a flame retardant combination useful for the invention may be alumina trihydrate and zinc borate in a ratio of 1:20 to 1:5 by weight.

The flame and oil resistant halogen-free composition of the invention has a flame retardant content of about 40% to about 80% by weight of the total composition, and in a more particular embodiment, the flame retardant content is about 50% to about 70% by weight.

### Other Compounds

The flame and oil resistant halogen-free composition may contain other compounds such as antioxidants, processing aids, lubricants, pigments, additives, fillers, and the like.

Suitable conventional antioxidants are, for example, polymerized trimethyldihydroquinoline, 4,4′-thiobis-(3-methyl-6-tere-butyl)phenol, pentaeritriltetra[3-(3,5-di-terebutyl-4-hydroxyphenyl)propionate] 2,2′-thiodiethylene bis[3-(3,5-di-tere-butyl-4-hydroxyphenyl)propionate], pentaerythritol tetrakis[3-(3,5-di-tert-butyl-4-hydroxyphenyl) propionate] and the like, or mixtures thereof. The flame and oil resistant halogen-free composition of the invention has an antioxidant content of about 0.125% to about 1% by weight of the total composition.

The processing aids are, for example, calcium stearate, zinc stearate, stearate acid, paraffin wax, rubber silicon and similar, or mixtures thereof.

The lubricants used are, for example, paraffin waxes of low molecular weight, stearic acid, stearamide, oleamide, erucamide. The halogen-free composition of high volume resistivity of the invention has a lubricant content of about 0.25% to about 2% by weight of the total composition.

The pigment in this type of compound are added in concentrated pigmenting substance dispersed in a base polymer which has the same chemical nature as the polymer to be pigmented, i.e. polyethylene to pigment, a pigment is used dispersed in polyethylene.

Other additives that can be used, are, for example, magnesium carbonate, zinc borate, silane trimethoxy vynil, silane triethoxy vynil, benzotriazoles, dispersed in disabled amines.

A wide variety of filling materials of mineral origin, useful as cost reducers may be useful in the flame and oil resistant halogen-free composition of the present invention. Examples of such filler materials of mineral origin include attapulgite, bentonite, calcium carbonate, talc, clay, quartz sand, diatomaceous earth, dolomite, feldspar, silicates, silica, kaolin, mica, perlite, vermiculite, wollastonite, and combinations thereof.

### EMBODIMENTS OF THE INVENTION

The invention will now be described with reference to the following examples, which are only intended to represent the manner of carrying out the implementation of the principles of the invention. The following examples are not intended as an exhaustive representation of the invention, neither intended to limit the scope thereof.

To carry out the examples of the present invention, combinations were used of chemical compounds as shown in Table 1. All these chemical compounds are commercially available and were used without a post-modification.

TABLE 1

| CHEMICAL COMPOUND | COMMERCIAL NAME | SUPPLIER |
|---|---|---|
| Poly(ethylene-co-vinyl acetate) | Elvax 265 | DuPont |
| 28% VA | | |
| Linear low density polyethylene | Fusabond MB 528 | DuPont |
| grafted with maleic anhydride | | |
| Linear low density polyethylene | DFDA 7540 NT | Dow Plastics |
| Alumina trihydrate | Micral 9400 | Hubber |
| Zinc borate | ZB2335 | Charlotte |
| | | Chemicals |
| Lubricant | TR121 | Struktol |
| Phenolic antioxidant | Irganox 1010 | BASF-CIBA |

As a control sample, said Example 1, produced a halogen-free composition with a formula of poly(ethylene-co-vinyl acetate) 28% VA, linear low density polyethylene grafted with maleic anhydride, alumina trihydrate, zinc borate, lubricant and phenolic antioxidant for which an internal Banbury type mixer was used of a capacity of 1,600 cm³. Likewise, flame and oil resistant halogen-free compositions, were prepared according to the invention, designated as Example 2 to Example 7, based on the composition of Example 1 but adding linear low density polyethylene. The precise composition of Examples 1 to 7 is shown in Tables 2 and 3.

After mixing of the chemical compounds to make each of Examples 1 to 7, each of the compositions were extruded on separate samples of electrical conductors covered respectively in a way of a sheath forming electrical wires. Examples 1 to 7 show the results of samples immersed in 100° C. for 96 hours. From these examples, only 3 of them were selected to be tested to oil immersion for 60 days at 60° C. (Examples 1-3). It is worth mentioning that the test of 60 days at 60° C. indicates the result, after a visual inspection, as a “pass” or “fail”.

### Description of Tests to Examples

a) Test of 96 hours at 100° C.: the immersed sample is elaborated with the corresponding composition to the selected example (sample type ASTM-D-638) in a container with oil at 100° C. for 96 hours. The initial mechanical properties (stress and elongation) are compared with the ones after immersion. This test was only conducted in test tubes.
b) Testing 60 days at 60° C.: the wire is dipped coated with the composition, in the form of a “U” where the cable ends are remaining out of contact with the oil, in an oil container at 60° C. for 60 days hours. After such period the wire is removed from the container with oil, cleaned and remains as such to reach the room temperature (temperized). Once the wire has been temperized, it is subjected to the testing of a “mandrel”. The test of the “mandrel” consists in positioning the cable on a “mandrel” and double it in the opposite direction to which the cable was subject during the 60 testing days. That is, the doubling occurs in the form of an inverted “U”. Once the mandrel test has been performed, a thorough inspection is done to the sheath of the conductor to find any tearing. Said inspection is only visual, and no mechanical tests are performed, or any other type that yield measurable results. This test was performed only in sheathed cables.

The Examples selected for tests on cable for 60 days at 60° C. were those that showed a higher value in retention properties to the elongation and stress after the immersion test in oil for 96 hours at 100° C.

The Examples selected for tests on cable 60 days at 60° C. were those that showed a higher value in retention properties and the elongation stress test after immersion in oil for 96 hours at 100° C.
a) Example 1: gave as a result a completely disintegrated sheath. It was performed in a test tube and on a cable.
b) Example 2: gave as a result that the sheath did not disintegrate after the immersion test and after the mandrel test it did not tear. Pass of the test of 60 days at 60° C.
c) Example 3: gave as a result that the sheath did not disintegrate after the immersion test and after the mandrel test it did not tear. Pass of the test of 60 days at 60° C.

The effect of the addition of linear low density polyethylene in Examples 2 to 7 is shown in Table 2 and 3, which shows that the tensile properties are not affected by immersion in oil.

TABLE 2

| | Example | | |
|---|---|---|---|
| | 1 | 2 | 3 |
| Chemical Compound | Weight % | Weight % | Weight % |
| Poly(ethylene-co-vinyl acetate) | 28.1 | 16.5 | 11.6 |
| 28% VA | | | |
| Linear low density polyethylene | 8.3 | 8.3 | 8.3 |
| grafted with maleic anhydride | | | |
| Linear low density polyethylene | 0 | 11.6 | 16.5 |
| Alumina trihydrate | 59.5 | 59.5 | 59.5 |
| Zinc borate | 3.3 | 3.3 | 3.3 |
| Lubricant | 0.7 | 0.7 | 0.7 |
| Phenolic antioxidant | 0.2 | 0.2 | 0.2 |
| TOTAL | 100 | 100 | 100 |
| Density, g/cm³ | 1.53 | 1.53 | 1.52 |
| Stress strength, MPa | 14.0 | 16.4 | 16.3 |
| Elongation, % | 158 | 142 | 142 |
| Tearing, N/cm | 8.9 | 12.1 | 10.7 |

Results of the immersion test in oil for 96 hours at 100° C.

| | | | |
|---|---|---|---|
| Retention of stress strength, % | Disintegrated | 18 | 30 |
| | in oil | | |
| Retention of elongation, % | Disintegrated | 35 | 76 |
| | in oil | | |

Results of the immersion test in oil for 60 hours at 60° C.

| | | |
|---|---|---|
| Disintegrated | Pass | Pass |
| in oil | | |

TABLE 3

| | Example | | | |
|---|---|---|---|---|
| | 4 | 5 | 6 | 7 |
| | Weight | Weight | Weight | Weight |
| Chemical Compound | % | % | % | % |
| Poly(ethylene-co-vinyl acetate) | 13.3 | 12.8 | 12.4 | 11.6 |
| 28% VA | | | | |
| Linear low density polyethylene | 9.5 | 9.2 | 8.8 | 8.3 |
| grafted with maleic anhydride | | | | |
| Linear low density polyethylene | 19.0 | 18.3 | 17.7 | 16.5 |
| Alumina trihydrate | 53.3 | 55.0 | 56.6 | 59.5 |
| Zinc borate | 3.8 | 3.7 | 3.5 | 3.3 |
| Lubricant | 0.8 | 0.7 | 0.7 | 0.7 |
| Phenolic antioxidant | 0.2 | 0.2 | 0.2 | 0.2 |
| TOTAL | 100 | 100 | 100 | 100 |
| Density, g/cm³ | 1.44 | 1.46 | 1.48 | 1.52 |
| Stress strength, MPa | 15.6 | 16.3 | 15.6 | 16.3 |
| Elongation, % | 183 | 200 | 158 | 142 |
| Tearing, N/cm | 15.8 | 15.9 | 12.1 | 10.7 |

Results of the immersion test in oil for 96 hours at 100° C.

| | | | | |
|---|---|---|---|---|
| Retention of stress strength, % | 27 | 25 | 27 | 30 |
| Retention of elongation, % | 68 | 75 | 79 | 76 |

Based on the above described embodiments, it is observed that modifications to these embodiments described and the alternative embodiments will be considered obvious to a person skilled in the art of the art under the present description. It is therefore considered that the claims encompass said alternative embodiments, and that they are within the scope of the present invention or its equivalents.

1. A flame and oil resistant halogen-free composition for an electrical cable sheath, comprising:
from 5% to 25% by weight of at least one ethylene copolymer;
from 5% to 25% by weight of linear low density polyethylene;
from 0.5% to 25% by weight of at least one polyolefin grafted with maleic anhydride; and
from 40% to 80% by weight of at least one flame retardant.

2. The flame and oil resistant halogen-free composition of claim 1, wherein said composition has a resistance to immersion in oil over 60 days at an oil temperature of 60° C.

3. The flame and oil resistant halogen-free composition of claim 1, wherein said composition has a strength retention to stress of 15% to 60% and a retention to elongation of 30% to 90% in a sample of immersion in oil for 90 hours at an oil temperature of 100° C.

4. The flame and oil resistant halogen-free composition of claim 1, wherein said linear low density polyethylene has a density of 0.89 g/cm3 to 0.93 g/cm3.

5. The flame and oil resistant halogen-free composition of claim 1, wherein said linear low density polyethylene has a melt index of 0.1 g/min to 25 g/min.

6. The flame and oil resistant halogen-free composition of claim 1, wherein said composition comprises from 10% to 15% by weight of linear low density polyethylene.

7. The flame and oil resistant halogen-free composition of claim 1, wherein said composition comprises from 10% to 20% by weight of ethylene copolymer.

8. The flame and oil resistant halogen-free composition of claim 1, wherein said ethylene copolymer is selected from a group consisting of vinyl ethylene-co-acetate, ethylene-co-1-hexene, ethylene-co-1-butene, ethylene-co-1-octene, ethylene-co-methylacrylate, ethylene-co-ethylacrylate, ethylene-co-butyl acrylate, ethylene-co-butyl acrylate-co-carbon monoxide, ethylene-co-vinylacetate-co-carbon monoxide, and combinations thereof.

9. The flame and oil resistant halogen-free composition of claim 1, wherein said composition comprises from 5% to 10% by weight of polyolefin grafted with maleic anhydride.

10. The flame and oil resistant halogen-free composition of claim 1, wherein the polyolefin grafted with maleic anhydride is selected from a group consisting of low density polyethylene grafted with maleic anhydride, linear low density polyethylene grafted with maleic anhydride, polypropylene grafted with maleic anhydride, high density polyethylene grafted with maleic anhydride, ethylene copolymer grafted with maleic anhydride, and combinations thereof.

11. The flame and oil resistant halogen-free composition of claim 1, wherein said composition comprises from 50% to 70% by weight of flame retardant.

12. The flame and oil resistant halogen-free composition of claim 1, wherein said flame retardant is selected from a group consisting of synthetic alumina trihydrate, treated alumina trihydrate, natural alumina trihydrate, synthetic magnesium hydroxide, natural magnesium hydroxide, treated magnesium hydroxide, synthetic magnesium-aluminum layered double hydroxide, treated magnesium-aluminum layered double hydroxide, natural magnesium-aluminum layered double hydroxide, zinc borate, and combinations thereof.

13. An electrical cable comprising:
at least one electrical conductor; and
at least one flame and oil resistant halogen-free sheath covering the electrical conductor;
wherein said flame and oil resistant halogen-free sheath includes:
from 5% to 25% by weight of at least one ethylene copolymer;
from 5% to 25% by weight of linear low density polyethylene;
from 0.5% to 25% by weight of at least one polyolefin grafted with maleic anhydride; and
from 40% to 80% by weight of at least one flame retardant.

14. The electrical cable of claim 13, wherein said sheath has a resistance to immersion in oil over 60 days at an oil temperature of 60° C.

15. The electrical cable of claim 13, wherein said sheath has a strength retention to stress of 15% to 60% and a retention to elongation of 30% to 90% in a sample of immersion in oil for 90 hours at an oil temperature of 100° C.

16. The electrical cable of claim 13, wherein said linear low density polyethylene of said sheath has a density of 0.89 g/cm3 to 0.93 g/cm³.

17. The electrical cable of claim 13, wherein said linear low density polyethylene of said sheath has a fluid density of 0.1 g/min to 25 g/min.

18. The electrical cable of claim 13, wherein said sheath comprises from 10% to 15% by weight of said linear low density polyethylene.

19. The electrical cable of claim 13, wherein said sheath comprises from 10% to 20% by weight of said ethylene copolymer.

20. The electrical cable of claim 13, wherein said ethylene copolymer of said sheath is selected from a group consisting of vinyl ethylene-co-acetate, ethylene-co-1-hexene, ethylene-co-1-butene, ethylene-co-1-octene, ethylene-co-methyl acrylate, ethylene-co-ethyl acrylate, ethylene-co-butyl acrylate, ethylene-co-butyl acrylate-co-carbon monoxide, ethylene-co-vinylacetate-co-carbon monoxide, and combinations thereof.

21. The electrical cable of claim 13, wherein said sheath comprises from 5% to 10% by weight of said polyolefin grafted with maleic anhydride.

22. The electrical cable of claim 13, wherein said polyolefin grafted with maleic anhydride of said sheath is selected from a group consisting of low density polyethylene grafted with maleic anhydride, linear low density polyethylene grafted with maleic anhydride, polypropylene grafted with maleic anhydride, high density polyethylene grafted with maleic anhydride, ethylene copolymer grafted with maleic anhydride, and combinations thereof.

23. The electrical cable of claim 13, wherein said sheath comprises from 50% to 70% by weight of said flame retardant.

24. The electrical cable of claim 13, wherein said flame retardant is selected from a group consisting of synthetic alumina trihydrate, treated alumina trihydrate, natural alumina trihydrate, synthetic magnesium hydroxide, natural magnesium hydroxide, treated magnesium hydroxide, synthetic magnesium-aluminum layered double hydroxide, treated magnesium-aluminum layered double hydroxide, natural magnesium-aluminum layered double hydroxide, zinc borate, and combinations thereof.
